(19) United States
(12) Patent Application Publication
(10) Pub. No.: US 2019/0205303 A1
(43) Pub. Date: Jul. 4, 2019

(54) DATA PROCESSING METHOD AND APPARATUS

(71) Applicant: ALIBABA GROUP HOLDING LIMITED, George Town (KY)

(72) Inventors: Qicheng WANG, Hangzhou (CN); Liang PAN, Hangzhou (CN); Jingfang ZHENG, Hangzhou (CN)

(73) Assignee: ALIBABA GROUP HOLDING LIMITED

(21) Appl. No.: 16/234,447

(22) Filed: Dec. 27, 2018

(30) Foreign Application Priority Data
Dec. 28, 2017 (CN) 201711455945.2

(51) Int. Cl. G06F 16/2453

(52) U.S. Cl. CPC G06F 16/24542

(57) ABSTRACT

Embodiments of the disclosure provide a method for processing data in a database, an apparatus, and a non-transitory computer readable medium. The method can include: receiving, from a user, a first operating instruction for selecting at least one data label of a plurality of generated data labels; determining a query statement and a data range based on the at least one data label; and generating a data query instruction according to the query statement and the data range.

### CROSS REFERENCE TO RELATED APPLICATION

The disclosure claims the benefits of priority to Chinese application number 201711455945.2, filed Dec. 28, 2017, which is incorporated herein by reference in its entirety.

### BACKGROUND

With the development of science and technology, various query language applications for data query are increasingly popular. For example, a Structured Query Language (SQL) is a database query language used to access data and to query, update, and manage a relationship database system.

Conventionally, when a data query is needed, a user may compile a data query instruction manually and then perform the data query through the data query instruction. Although the data query instruction has higher flexibility and more functions, compilation of the data query instruction can be complex and quite time-consuming for the user.

How to generate a data query instruction more quickly is still a technical problem that urgently needs to be solved in this field.

### SUMMARY OF THE DISCLOSURE

Embodiments of the disclosure provide a method for processing data in a database. The method can include: receiving, from a user, a first operating instruction for selecting at least one data label of a plurality of generated data labels; determining a query statement and a data range based on the at least one data label; and generating a data query instruction according to the query statement and the data range.

Embodiments of the disclosure further provide an apparatus for processing data in a database. The apparatus can include: a memory storing a set of instructions; a communication interface configured to receive a first operation instruction for selecting at least one data label of a plurality of generated data labels; and at least one processor configured to execute the set of instructions to cause the apparatus to perform: determining a query statement and a data range based on the at least one data label; and generating a data query instruction according to the query statement and the data range.

Embodiments of the disclosure also provide a non-transitory computer readable medium that stores a set of instructions that is executable by at least one processor of a computer system to cause the computer system to perform a method for processing data in a database. The method can include: receiving, from a user, a first operating instruction for selecting at least one data label of a plurality of generated data labels; determining a query statement and a data range based on the at least one data label; and generating a data query instruction according to the query statement and the data range.

### BRIEF DESCRIPTION OF THE DRAWINGS

To describe the technical solutions in embodiments of the disclosure or in the prior art more clearly, accompanying drawings to be used in the descriptions of the embodiments or the prior art are described briefly as follows.

FIG. 1 is a flowchart of a data processing method, according to embodiments of the disclosure.

FIG. 2 is a flowchart of another data processing method, according to embodiments of the disclosure.

FIG. 3 is a flowchart of yet another data processing method, according to embodiments of the disclosure.

FIG. 4 is a schematic diagram of a data label, according to embodiments of the disclosure.

FIG. 5 is a schematic diagram of column data, according to embodiments of the disclosure.

FIG. 6 is a schematic structural diagram of a data processing apparatus, according to embodiments of the disclosure.

### DETAILED DESCRIPTION

The present disclosure discloses a data processing method and apparatus, and those skilled in the art can appropriately improve process parameters for implementation with reference to the content of this text. It should be specifically pointed out that all similar replacements and modifications are apparent for those skilled in the art and are all considered as being encompassed in the disclosure. The method and application of the disclosure have been described through preferred embodiments, and it is apparent that related personnel can implement and apply techniques of the disclosure by modifying or properly changing and combining the method and application described in this text without departing from the content, spirit and scope of the disclosure.

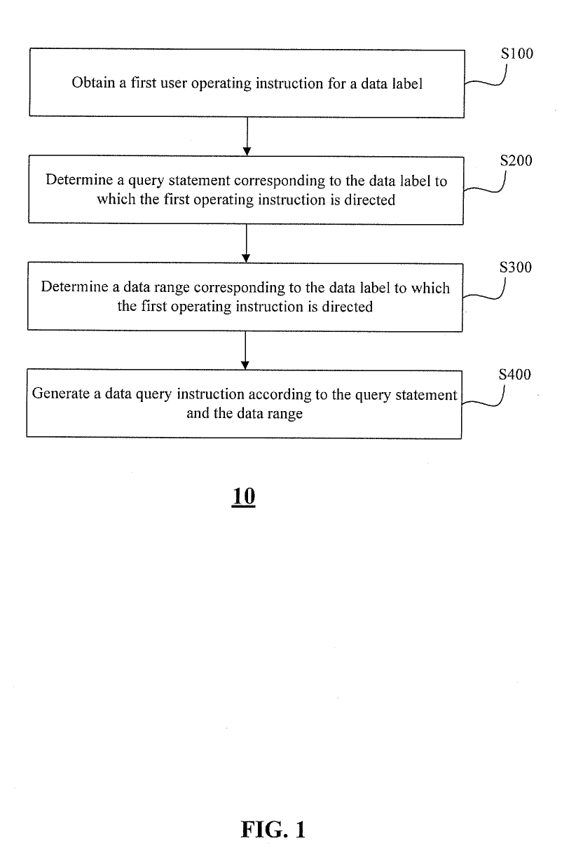

As shown in FIG. 1, embodiments of the disclosure provide a data processing method 10. Data processing method 10 can include steps S100-S400.

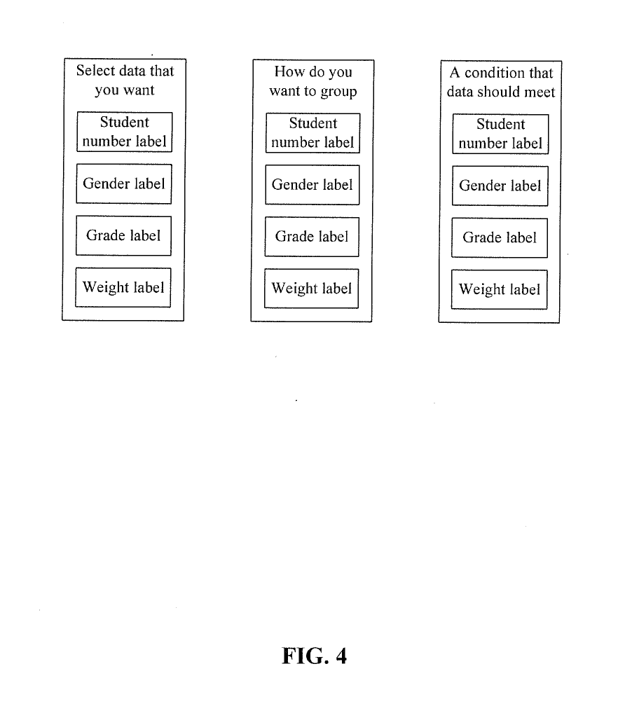

In step S100, a first user operating instruction for a data label can be obtained. The data label can be of multiple types, such as a condition type, a grouping type, and an output type. Different type identifications can be set for different types of labels, or different types of labels can be set in different display areas. Various types of data labels can further be identified by using colors and texts, such that a user knows label types of the data labels. FIG. 4 is a schematic diagram of a data label, according to embodiments of the disclosure.

As shown in FIG. 4, label types of data labels can be indicated by using texts above labels such as “select data that you want”, “how do you want to group”, and “a condition that data should meet.” For example, a label type of a label under the text “select data that you want” and indicated by the text is an output type.

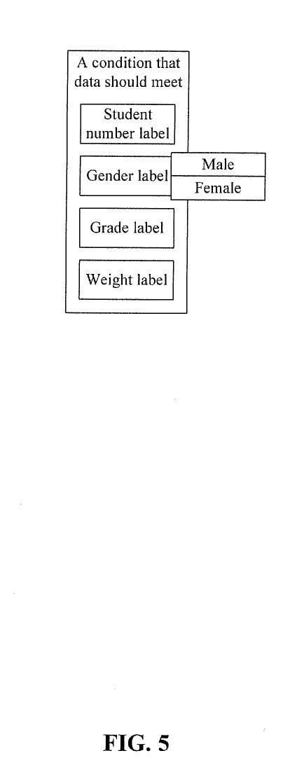

In some embodiments, the data labels can correspond to data ranges in a data table. The data ranges can include, for example, data columns, data rows, or data regions defined by row numbers and column numbers. For example, in Table 1 and Table 2 as shown below, data labels corresponding to data columns can be generated. The data labels can include a student number label, a gender label, a grade label, and a weight label. Further, data items can further be set for the data labels for the user to select. For example, as shown in FIG. 5, data items for a gender label can include male and female.

TABLE 1
Student Grade Table

| Student Number | Gender | Grade |
|---|---|---|
| 000001 | Female | Grade One |
| 000002 | Male | Grade Two |
| 000003 | Female | Grade One |
| . . . | . . . | . . . |
| 001001 | Male | Grade Six |

TABLE 2
Student Weight Table

| Student Number | Weight |
|---|---|
| 000001 | 20 kg |
| 000002 | 30 kg |
| 000003 | 17 kg |
| . . . | . . . |
| 001001 | 50 kg |

In some embodiments, the data labels can further correspond to primary key columns in the data table. That is, the data labels correspond to the data columns and the primary key columns. A primary key is a primary key field that can uniquely identify every record in the data table. In Table 1, the gender label generated in the disclosure can correspond to a gender column and a student number column. The gender column is a data column, and the student number column is a primary key column. In some embodiments, data columns corresponding to data labels can be associated with the primary key columns. For example, in Table 1, to output records of female students of Grade One, data in the gender column can be associated with data in the grade column by student numbers in the student number column.

In some embodiments, data labels corresponding to partial data ranges can be generated. For example, in Table 1, data labels corresponding to the gender column and data labels corresponding to the grade column may be generated, while data labels corresponding to the student number column may not be generated. In some embodiments, data labels can be generated based on associated data ranges of another table. The associated data range can include columns or rows that exist in different data tables. For example, the student number column in Table 1 and Table 2 can be an associated data range (i.e., an associated column). Data in Table 1 and Table 2 can be associated together through the associated data range. The associated data can be included in the associated column (e.g., the student number column), and the associated column can be the primary key column.

The first operating instruction in step S100 can include a selection instruction for a data item. The selection instruction can further include a condition type for a data item of a data label.

In some embodiments, data labels of various label types can be set based on characteristics of the SQL. For example, a data label of the output type and a data label of the condition type are set. When the first operating instruction is directed to the data label of the output type, it indicates that data corresponding to the data label of the output type can be used as an output result. When the first operating instruction is directed to the data label of the condition type, it indicates that the output data meets a data requirement corresponding to the condition type. For example, the data requirement can be that the output data corresponds to a data option selected by the user.

In step S200, a query statement corresponding to the data label to which the first operating instruction is directed can be determined. In some embodiments, a query statement corresponding to the data label can be determined according to the label type of the data label. For example, when a label type of a data label includes an output type, a query statement corresponding to the data label of the output type can be determined as an output statement. When a label type of the label includes a condition type, a query statement corresponding to the data label of the condition type can be determined as a condition statement. When a label type of a data label includes the grouping type, a query statement corresponding to the data label of the grouping type can be determined as a grouping statement, a condition statement, and an output statement.

In step S300, a data range corresponding to the data label to which the first operating instruction is directed can be determined. The data range determined in step S300 can include a data column, a data row, a data region limited by a row number and a column number, and the like.

In step S400, a data query instruction can be generated according to the query statement and the data range. The data query instruction generated in step S400 can be a SQL instruction. In some embodiments, a data query instruction can be generated by placing a column name of the data column and a table name of a data table including the data column behind a query statement.

The data processing method can obtain a first user operating instruction for a data label, determine a query statement corresponding to the data label to which the first operating instruction is directed, determine a data range corresponding to the data label to which the first operating instruction is directed, and generate a data query instruction according to the query statement and the data range. Therefore, a data query instruction can be generated automatically according to user operating instructions for a data label without manual writing by the user, making it more convenient.

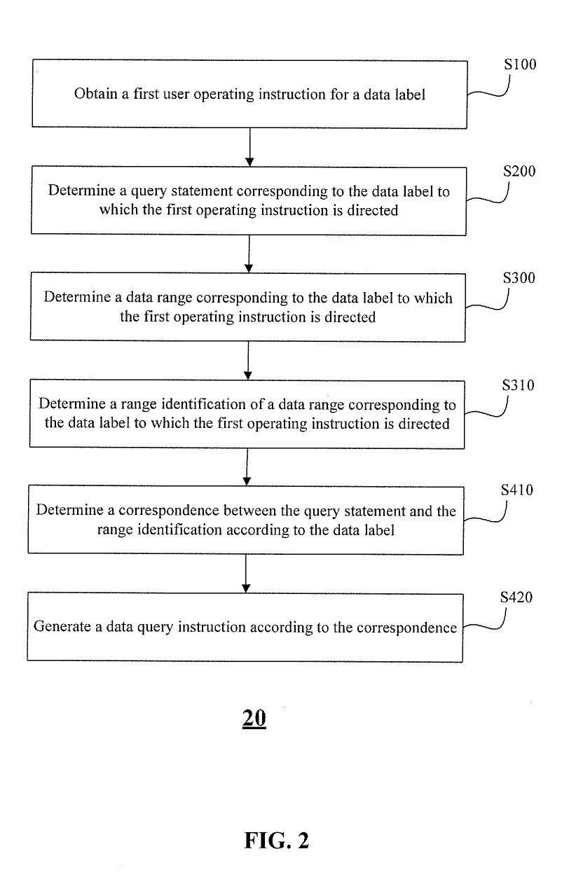

FIG. 2 is a flowchart of another data processing method 20, according to embodiments of the disclosure. Data processing method 20 can include steps S100, S200, S300, S310, S410, and S420.

In step S100, a first user operating instruction for a data label can be obtained.

In step S200, a query statement corresponding to the data label to which the first operating instruction is directed can be determined.

Step S200 can further include determining a label type of the data label to which the first operating instruction is directed, and determining, based on the label type of the data label to which the first operating instruction is directed, a query statement corresponding to the data label to which the first operating instruction is directed; and determining a query statement corresponding to all data labels to which the first operating instruction is directed as a query object statement.

The query object can be a table, and the query object statement can include a destination table statement.

The step of determining a label type of the data label to which the first operating instruction is directed can further include: determining, based on a type identification of the data label to which the first operating instruction is directed, a label type of the data label to which the first operating instruction is directed; or determining, based on a display position of the data label to which the first operating instruction is directed, a label type of the data label to which the first operating instruction is directed.

In some embodiments, determining the query statement corresponding to the data label based on the label type of the data label can further include: when the label type of the data label to which the first operating instruction is directed includes an output type, determining a query statement corresponding to the data label of the output type to which the first operating instruction is directed as an output statement; when the label type of the data label to which the first operating instruction is directed includes a condition type, determining a query statement corresponding to the data label of the condition type to which the first operating instruction is directed as a condition statement; and when the label type of the data label to which the first operating instruction is directed includes a grouping type, determining a query statement corresponding to the data label of the grouping type to which the first operating instruction is directed as a grouping statement, a condition statement, and an output statement.

The output statement can be “select,” the condition statement can be “where,” and the grouping statement can be “group by.” The label types of the data labels may not be limited to the above types, such as the output type, the condition type, and the grouping type. The query statements determined according to the label types are, therefore, not limited to the types such as “select,” “where,” and “group by.”

The destination table statement can be “from.” When a data query instruction is executed, it is required to operate data in a query object (e.g., a data table) corresponding to each data label to which the first operating instruction is directed. Therefore, data labels to which the first operating instruction is directed correspond to “from.”

In step S300, a data range corresponding to the data label to which the first operating instruction is directed can be determined.

In step S310, a range identification of the data range corresponding to the data label can be determined. When the data range is the data column, the range identification of the data range can include a column name of the data column, and a table name of a data table including the data column. For example, a column name of a data column corresponding to the gender label is gender, and a table name of a data table where the data column corresponding to the gender label is located is student grade table.

After step S310, method 20 can further include step S400 described with reference to FIG. 1. In method 20, step S400 can further include steps S410 and S420.

In step S410, a correspondence between the query statement and the range identification can be determined according to the data label. For example, with reference back to Table 1 and Table 2, the label type of the gender label can be a condition type, and a correspondence between the condition statement (e.g., “where”), the gender, and the student grade table can be determined.

In step S420, a data query instruction can be generated according to the correspondence.

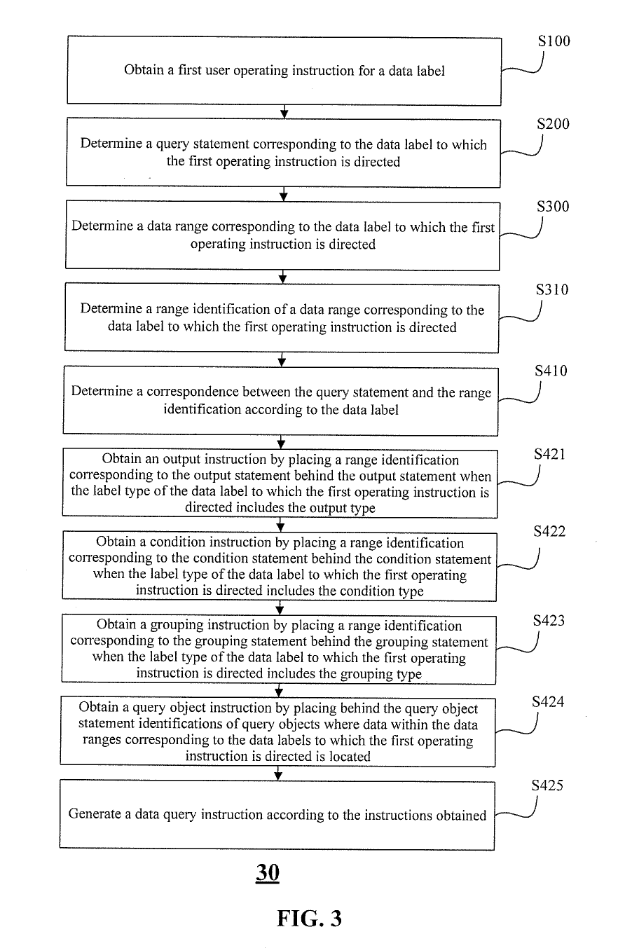

FIG. 3 is a flowchart of yet another data processing method 30, according to embodiments of the disclosure. In FIG. 3, step S420 of method 30 can further include a step S421.

In step S421, an output instruction can be obtained by placing a range identification corresponding to the output statement behind the output statement, when the label type of the data label includes the output type.

With reference to FIG. 4, for example, the first operating instruction of the user can include clicking a weight label under the text “select data that you want.” The clicking can indicate that the label type of the weight label is now the output type. A query statement corresponding to the weight label can be “select,” and a range identification corresponding to select includes a table name and a column name. The table name can indicate the data table including a data column corresponding to the weight label (e.g., student weight table). The column name can indicate a data column corresponding to the weight label (e.g., Weight). Referring back to FIG. 3, in step S421, an output instruction can be obtained by placing the student weight table and the weight behind the “select” statement. The output instruction can be, for example, “select student weight table.weight.”

In step S422, a condition instruction can be obtained by placing a range identification corresponding to the condition statement behind the condition statement when the label type of the data label includes the condition type. The first operating instruction in method 30 can include a selection instruction for a data item of the data label of the condition type, and method 30 can further include determining data corresponding to the data item. For example, the data corresponding to the data item can be data in the data column, which can be referred to as column data for short.

Step S422 can further include obtaining a data condition by connecting the data corresponding to the data item to the range identification through a first operator group when the label type of the data label to which the first operating instruction is directed includes the condition type; and obtaining a condition instruction by placing the data condition behind the condition statement.

For example, with reference to FIG. 4 and FIG. 5, the first operating instruction of the user can include clicking the gender label under the text “a condition that data should meet” shown in FIG. 4 and clicking the column data “female” corresponding to the gender label as shown in FIG. 5. Therefore, the label type of the gender label can be determined as the condition type. The query statement corresponding to the gender label is “where,” and the table name corresponding to “where” is a table name (e.g., student grade table) of the data table including the data column corresponding to the gender label. The column name (e.g., gender) corresponding to “where” is the column name of the data column corresponding to the gender label. In some embodiments, the table name and the column name can be connected to the column data by using an operator “=” to obtain a data condition: student grade table.gender=female. The data condition is placed behind “where” to obtain a condition instruction. The condition instruction can be, for example, “where student grade table.gender=female.”

In some embodiments, the user can further click a plurality of condition labels and determine a data condition according to the plurality of clicked condition labels. A plurality of logical relationship labels can further be provided for the user to select, such that the user sets a relationship between the plurality of condition labels clicked by the user. A logical identifier corresponding to the logical relationship label can include “and”, “or”, or the like.

Method 30 can further include: obtaining a second operating instruction of the user for a logical relationship label; and determining, according to the first operating instruction and the second operating instruction, a logical relationship between data labels of the condition type to which the first operating instruction is directed.

After obtaining the condition instruction by placing the data condition behind the condition statement, method 30 can further include: obtaining a condition instruction by connecting data conditions through a logical identifier corresponding to the determined logical relationship and placing the data conditions connected through the logical identifier behind the condition statement.

In step S423, a grouping instruction can be obtained by placing a range identification corresponding to the grouping statement behind the grouping statement when the label type of the data label includes the grouping type.

For example, the first user operating instruction can include: clicking a grade label under the text “how do you want to group” as shown in FIG. 4. The label type of the grade label can be determined as the grouping type. The query statement corresponding to the grade label is “group by”, and the table name corresponding to “group by” is the table name (e.g., the student grade table) of the data table including the data column corresponding to the grade label. The column name corresponding to “group by” is the column name (e.g., grade) of the data column corresponding to the grade label. In step S423, a grouping instruction can be obtained by placing “student grade table” and “grade” behind “group by.” The grouping instruction can be, for example, “group by student grade table.grade.”

The user can click the data label of the grouping type to group output results. To distinguish groups respectively corresponding to outputs, the table name and the column name corresponding to the grouping statement can be further placed behind the output statement. As such, corresponding groups can be seen in the output results.

For example, with reference to Table 1 and Table 2, the grouping instruction can be “group by student grade table.grade,” and the output instruction can be “select student weight table.weight.” “student grade table.grade” can also be placed behind “select” to obtain an output instruction as below:

select student weight table.weight,

student grade table.grade.

As such, in the output results, weight and grade will correspond to outputs, such that the user knows weights of the grades.

In step S424, a query object instruction can be obtained by placing identifications of query objects including data within the data ranges corresponding to the data labels behind the query object statement. For example, the query object can be a data table, and the identification of the query object can be a table name of the data table. The query object statement can be a destination table statement.

Step S424 can further include generating a cross-query object condition according to an associated data range when identifications of query objects where data within the data ranges corresponding to the data labels to which the first operating instruction is directed is located at least include two different identifications; and obtaining a query object instruction by placing behind the query object statement the cross-query object condition and the identifications of the query objects where data within the data ranges corresponding to the data labels to which the first operating instruction is directed is located.

In some embodiments, step S424 can include: generating a cross-table condition according to an associated column when the table name of the data table where the data column corresponding to the data label to which the first operating instruction is directed is located at least includes two different table names; and obtaining a destination table instruction by placing behind the destination table statement the table names of the data tables where the data columns corresponding to the data labels to which the first operating instruction is directed are located.

For example, the destination table instruction can be obtained by connecting the cross-table condition to the table name through a second operator group and placing the connected cross-table condition and table name behind the destination table statement. The second operator group can include operators “join” and “on.” “join” can be used to connect different table names, and “on” can be used to connect the table name and the cross-table condition.

Generating a cross-query object condition according to an associated data range can include: obtaining a range identification of an associated data range in a query object corresponding to an identification of each query object; determining the range identification of the associated data range and the identification of the query object where data within the associated data range is located as association conditions; and obtaining a cross-query object condition by connecting the association conditions through a connection statement.

The associated data range can be an associated column, and the range identification of the associated data range can be a column name of the associated column.

The associated column can be a column that is associated between different tables. For example, the student number column in Table 1 and the student number column in Table 2 are associated, and the student number column is the associated column. Therefore, data in Table 1 and Table 2 can be correspondingly placed according to the student number columns in the two tables, so as to use data in a cross-table manner. With reference to Table 1 and Table 2, the cross-table condition can be “student grade table.student number=student weight table.student number.” When the data columns corresponding to the data labels of the user are located in Table 1 and Table 2, respectively, the table names of Table 1 and Table 2 and the cross-table condition can be placed behind “from” to obtain a destination table instruction. The destination table instruction can be:

from student grade table,

join student weight table,

on student grade table.student number=student weight table.student number.

In step S425, a data query instruction can be generated according to the obtained instruction.

The sequential order of step S421 through step S424 is not limited in the disclosure.

In some embodiments, the data can further be output after being processed through some output functions, such as average calculation.

In some embodiments, method 30 can further include: obtaining a third operating instruction of the user for an output function label; and determining an output function statement corresponding to the output function label to which the third operating instruction is directed.

Step S421 can further include: obtaining an output instruction by combining the range identification corresponding to the output statement with the output function statement, and placing the combined statement behind the output statement.

The output function label to which the third operating instruction is directed can be set as an average label. Therefore, an output function statement can be determined as “avg.” Before the average label is clicked, the original output instruction can be:

select student weight table.weight,

student grade table.grade.

After the average label is clicked, an obtained output instruction can be:

select avg (student weight table.weight),

student grade table.grade.

Further with reference to Table 1 and Table 2, when the user expects to obtain an average weight of female students of each grade, the user can sequentially click the average label, the weight label under the text “select data that you want” as shown in FIG. 4, the grade label under “how do you want to group,” the gender label under the text “a condition that data should meet,” and the column data “female” corresponding to the gender label shown in FIG. 5. Then, the following data query instruction can be obtained according to the sequential clicking operations.

select avg (student weight table.weight),

student grade table.grade,

from student grade table,

join student weight table,

on student grade table.student number=student weight table.student number,

where student grade table.gender=female,

group by student grade table.grade,

The average weight of female students of each grade can be outputted by executing the above data query instructions.

Embodiments of the disclosure further provide a data processing apparatus.

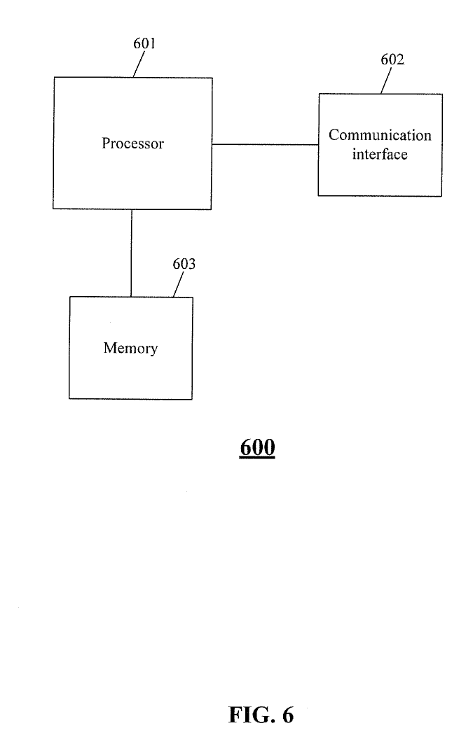

FIG. 6 is a schematic structural diagram of a data processing apparatus 600, according to embodiments of the disclosure. Data processing apparatus 600 can include a processor 601, a communication interface 602, and a memory 603.

Memory 603 can store a set of instructions. Processor 601 can execute the set of instructions to cause apparatus 600 to perform the above described method.

Communication interface 602 is configured to obtain a first operating instruction of a user for a data label. In some embodiments, communication interface 602 can obtain operation instructions that are input locally or remotely. For example, a user can input an operation instruction via a key board, a touchscreen, or a port. Thus, communication interface 602 can be a Universal Serial Bus (USB) interface, a touchscreen, a port, an integrated services digital network (ISDN) card, cable modem, satellite modem, or a modem to provide a data communication connection. In some embodiments, communication interface 602 can receive instructions from processor to obtain the first operating instruction.

Processor 601 can be configured to determine a query statement corresponding to the data label to which the first operating instruction is directed, determine a data range corresponding to the data label to which the first operating instruction is directed, and generate a data query instruction according to the query statement and the data range.

The data label can be of multiple types, such as a condition type, a grouping type, and an output type. In the disclosure, different type identifications can be set for different types of labels, or different types of labels are set in different display areas.

For example, the data labels can correspond to data ranges (e.g., data columns, data rows, or data regions limited by row numbers and column numbers jointly) in a data table. In an actual application, in addition to corresponding to the data columns in the data table, the data labels can further correspond to primary key columns in the data table. That is, the data labels correspond to the data columns and the primary key columns. A primary key is a primary key field that can uniquely identify each record in the data table.

The first operating instruction can include a selection instruction for a data item and can further include a selection instruction for a data item of a data label of a condition type.

In the disclosure, data labels of various label types can be set based on characteristics of the SQL. For example, a data label of the output type and a data label of the condition type are set. When the first operating instruction is directed to the data label of the output type, it indicates that the user expects that data corresponding to the data label of the output type is used as one of output results. When the first operating instruction is directed to the data label of the condition type, it indicates that the user expects that output data at least meets a data requirement corresponding to the data label of the condition type. The data requirement can be that the output data corresponds to a data option selected by the user.

Processor 601 can be configured to determine a query statement corresponding to the data label according to the label type of the data label. For example, the data range can be a data column, a data row, a data region limited by a row number and a column number jointly, etc.

The data query instruction generated by processor 601 can specifically be: a SQL instruction.

After determining a data range corresponding to the data label to which the first operating instruction is directed, processor 601 can further be configured to determine a range identification of the data range corresponding to the data label to which the first operating instruction is directed.

Processor 601 can be configured to determine a correspondence between the query statement and the range identification according to the data label and generate a data query instruction according to the correspondence.

When the data range is the data column, the range identification of the data range can include: a column name of the data column, and a table name of a data table where the data column is located.

For example, processor 601 can be configured to determine a label type of the data label to which the first operating instruction is directed, determine, based on a label type of the data label to which the first operating instruction is directed, a query statement corresponding to the data label to which the first operating instruction is directed, and determine a query statement corresponding to all data labels to which the first operating instruction is directed as a query object statement.

The query object can be a table, and the query object statement can be: a destination table statement.

For example, when the label type of the data label to which the first operating instruction is directed includes an output type, processor 601 can be configured to determine a query statement corresponding to the data label of the output type to which the first operating instruction is directed as an output statement.

When the label type of the data label to which the first operating instruction is directed includes a condition type, processor 601 can be configured to determine a query statement corresponding to the data label of the condition type to which the first operating instruction is directed as a condition statement.

When the label type of the data label to which the first operating instruction is directed includes a grouping type, processor 601 can be configured to determine a query statement corresponding to the data label of the grouping type to which the first operating instruction is directed as a grouping statement, a condition statement, and an output statement.

The output statement can be select, the condition statement can be “where,” and the grouping statement can be “group by.” Definitely, the label types of the data labels in the embodiment of the disclosure may not be limited to the several types such as the output type, the condition type and the grouping type. Correspondingly, the query statements determined according to the label types in the disclosure are not limited to the several types such as “select,” “where,” and “group by,” etc.

The destination table statement can be “from.” When a data query instruction is executed, it is required to operate data in a query object (e.g., a data table) corresponding to each data label to which the first operating instruction is directed; therefore, in the disclosure, it can be determined that data labels to which the first operating instruction is directed all correspond to “from.”

For example, processor 601 can be configured to obtain an output instruction by placing a range identification corresponding to the output statement behind the output statement when the label type of the data label to which the first operating instruction is directed includes the output type.

Processor 601 can be configured to obtain a condition instruction by placing a range identification corresponding to the condition statement behind the condition statement when the label type of the data label to which the first operating instruction is directed includes the condition type.

Processor 601 can be configured to obtain a grouping instruction by placing a range identification corresponding to the grouping statement behind the grouping statement when the label type of the data label to which the first operating instruction is directed includes the grouping type.

Processor 601 can be configured to obtain a query object instruction by placing behind the query object statement identifications of query objects where data within the data ranges corresponding to the data labels to which the first operating instruction is directed is located.

Processor 601 can be configured to generate a data query instruction according to the obtained instructions. The query object can be a data table, and, therefore, the identification of the query object can be a table name of the data table. The query object statement can be a destination table statement.

For example, the first operating instruction includes a selection instruction for a data item of the data label of the condition type, and the processor 601 can further be configured to determine data corresponding to the data item to which the selection instruction is directed.

Processor 601 can be configured to obtain a data condition by connecting the data corresponding to the data item to the range identification through a first operator group when the label type of the data label to which the first operating instruction is directed includes the condition type, and obtain a condition instruction by placing the data condition behind the condition statement.

For example, the data corresponding to the data item to which the selection instruction is directed can be data in the data column, which is simply called column data.

In some embodiments of the disclosure, communication interface 602 can further be configured to obtain a second operating instruction of the user for a logical relationship label.

Processor 601 can be configured to determine, according to the first operating instruction and the second operating instruction, a logical relationship between data labels of the condition type to which the first operating instruction is directed, and obtain a condition instruction by connecting data conditions through a logical identifier corresponding to the determined logical relationship and placing the data conditions connected through the logical identifier behind the condition statement.

In some embodiments of the disclosure, communication interface 602 can further be configured to obtain a third operating instruction of the user for an output function label.

Processor 601 can be configured to determine an output function statement corresponding to the output function label to which the third operating instruction is directed, and obtain an output instruction by combining the range identification corresponding to the output statement with the output function statement, and placing the combined statement behind the output statement.

For example, processor 601 can be configured to generate a cross-query object condition according to an associated data range when identifications of query objects where data within the data ranges corresponding to the data labels to which the first operating instruction is directed is located at least include two different identifications.

Processor 601 can be configured to obtain a query object instruction by placing behind the query object statement the cross-query object condition and the identifications of the query objects where data within the data ranges corresponding to the data labels to which the first operating instruction is directed is located.

For example, processor 601 can be configured to obtain an identification of association data in a query object corresponding to an identification of each query object, determine the identification of the association data and the identification of the query object where the association data is located as association conditions, and obtain a cross-query object condition by connecting the association conditions with a preset connection statement.

The associated data range can be an associated column, and the range identification of the associated data range can be a column name of the associated column.

A data processing apparatus provided in the embodiments of the disclosure can obtain a first user operating instruction for a data label, determine a query statement corresponding to the data label to which the first operating instruction is directed, determine a data range corresponding to the data label to which the first operating instruction is directed, and generate a data query instruction according to the query statement and the data range. In the disclosure, a data query instruction can be generated automatically according to user operating instructions for a data label without manual writing by the user, making it more convenient.

The above descriptions are merely preferred implementation manners of the disclosure. It should be noted that persons of ordinary skill in the art can further make several improvements and modifications without departing from the principle of the disclosure, and the improvements and modifications should also be regarded as the protection scope of the disclosure.

1. A method for processing data in a database, comprising:
receiving, from a user, a first operating instruction for selecting at least one data label of a plurality of generated data labels;
determining a query statement and a data range based on the at least one data label; and
generating a data query instruction according to the query statement and the data range.

2. The method according to claim 1, wherein:
determining the query statement and the data range based on the at least one data label further comprises determining a range identification of the data range; and
generating the data query instruction further comprises generating the data query instruction based on the range identification and the query statement.

3. The method according to claim 1, wherein determining the query statement and the data range based on the at least one data label further comprises:
determining a label type of each of the at least one data label;
determining, based on the label type of each of the at least one data label, the query statement; and
determining a query statement corresponding to all of the at least one data label as a query object statement.

4. The method according to claim 3, wherein the label type includes an output type, a condition type, or a grouping type, and
when the label type includes the output type, the query statement includes an output statement;
when the label type includes a condition type, the query statement includes a condition statement; and
when the label type includes a grouping type, the query statement includes a grouping statement, the condition statement, and the output statement.

5. The method according to claim 4, wherein generating the data query instruction based on the range identification and the query statement further comprises:
in response to the label type including the output type, obtaining an output instruction as the data query instruction by placing the range identification behind the output statement;
in response to the label type including the condition type, obtaining a condition instruction as the data query instruction by placing the range identification behind the condition statement;
in response to the label type including the grouping type, obtaining a grouping instruction by placing the range identification behind the grouping statement; or
obtaining a query object instruction as the data query instruction by placing identifications of query objects behind the query object statement.

6. The method according to claim 5, wherein the first operating instruction comprises a selection instruction for a data item of the condition type, and the method further comprises:
determining data corresponding to a data item to which the selection instruction is directed; and
obtaining the condition instruction as the data query instruction by placing the range identification behind the condition statement further comprises:
obtaining a data condition by combining the data to the range identification through a first operator group; and
obtaining the condition instruction by placing the data condition behind the condition statement.

7. The method according to claim 6, further comprising:
obtaining a second user operating instruction based on a logical relationship label that indicates a relationship between the data labels of the condition type;
determining a logical identifier corresponding to the logical relationship label; and
wherein obtaining the condition instruction further comprises obtaining the condition instruction by placing data conditions combined with the logical identifier behind the condition statement.

8. The method according to claim 5, further comprising:
obtaining a third user operating instruction on an output function label for an output function; and
determining an output function statement corresponding to the output function label;
wherein obtaining the output instruction further comprises obtaining the output instruction by placing the range identification combined with the output function statement behind the output statement.

9. The method according to claim 5, wherein generating the query object instruction as the data query instruction by placing identifications of query objects behind the query object statement further comprises:
determining the query objects according to the data labels;
in response to at least two query objects being determined, generating an associated data range including data of the at least two query objects;
generating a cross-query-object condition according to the associated data range; and
obtaining a query object instruction by placing the cross-query object condition and the identifications of the query objects behind the query object statement.

10. The method according to claim 9, wherein generating the cross-query-object condition according to the associated data range further comprises:
obtaining a range identification of the associated data range;
generating association conditions based on the range identification of the associated data range and the identification of the query object; and
obtaining the cross-query-object condition by combining the association conditions via a connection statement.

11. An apparatus for processing data in a database, comprising:
a memory storing a set of instructions;
a communication interface configured to receive a first operation instruction for selecting at least one data label of a plurality of generated data labels; and
at least one processor configured to execute the set of instructions to cause the apparatus to perform:
determining a query statement and a data range based on the at least one data label; and
generating a data query instruction according to the query statement and the data range.

12-20. (canceled)

21. A non-transitory computer readable medium that stores a set of instructions that is executable by at least one processor of a computer system to cause the computer system to perform a method for processing data in a database, the method comprising:
receiving, from a user, a first operating instruction for selecting at least one data label of a plurality of generated data labels;
determining a query statement and a data range based on the at least one data label; and
generating a data query instruction according to the query statement and the data range.

22. The non-transitory computer readable medium according to claim 21, wherein determining the query statement and the data range based on the at least one data label further comprises:
determining the query statement and the data range based on the at least one data label further comprises determining a range identification of the data range; and
generating the data query instruction further comprises generating the data query instruction based on the range identification and the query statement.

23. The non-transitory computer readable medium according to claim 21, wherein determining the query statement and the data range based on the at least one data label further comprises:
determining a label type of each of the at least one data label;
determining, based on the label type of each of the at least one data label, the query statement; and
determining a query statement corresponding to all of the at least one data label as a query object statement.

24. The non-transitory computer readable medium according to claim 23, wherein the label type includes an output type, a condition type, or a grouping type, and
when the label type includes the output type, the query statement includes an output statement;
when the label type includes a condition type, the query statement includes a condition statement; and
when the label type includes a grouping type, the query statement includes a grouping statement, the condition statement, and the output statement.

25. The non-transitory computer readable medium according to claim 24, wherein generating the data query instruction based on the range identification and the query statement further comprises:
in response to the label type including the output type, obtaining an output instruction as the data query instruction by placing the range identification behind the output statement;
in response to the label type including the condition type, obtaining a condition instruction as the data query instruction by placing the range identification behind the condition statement;
in response to the label type including the grouping type, obtaining a grouping instruction by placing the range identification behind the grouping statement; or
obtaining a query object instruction as the data query instruction by placing identifications of query objects behind the query object statement.

26. The non-transitory computer readable medium according to claim 25, wherein the first operating instruction comprises a selection instruction for a data item of the condition type, and the set of instructions is executable by the at least one processor of the computer system to cause the computer system to further perform:
determining data corresponding to a data item to which the selection instruction is directed; and
obtaining the condition instruction as the data query instruction by placing the range identification behind the condition statement further comprises:
obtaining a data condition by combining the data to the range identification through a first operator group; and
obtaining the condition instruction by placing the data condition behind the condition statement.

27. The non-transitory computer readable medium according to claim 26, wherein the set of instructions is executable by the at least one processor of the computer system to cause the computer system to further perform:
obtaining a second user operating instruction based on a logical relationship label that indicates a relationship between the data labels of the condition type;
determining a logical identifier corresponding to the logical relationship label; and
wherein obtaining the condition instruction further comprises obtaining the condition instruction by placing data conditions combined with the logical identifier behind the condition statement.

28. The non-transitory computer readable medium according to claim 25, wherein the set of instructions is executable by the at least one processor of the computer system to cause the computer system to further perform:
obtaining a third user operating instruction on an output function label for an output function; and
determining an output function statement corresponding to the output function label;
wherein obtaining the output instruction further comprises obtaining the output instruction by placing the range identification combined with the output function statement behind the output statement.

29. The non-transitory computer readable medium according to claim 25, wherein generating the query object instruction as the data query instruction by placing identifications of query objects behind the query object statement further comprises:
determining the query objects according to the data labels;
in response to at least two query objects being determined, generating an associated data range including data of the at least two query objects;
generating a cross-query-object condition according to the associated data range; and
obtaining a query object instruction by placing the cross-query object condition and the identifications of the query objects behind the query object statement.

30. The non-transitory computer readable medium according to claim 29, wherein generating the cross-query-object condition according to the associated data range further comprises:
obtaining a range identification of the associated data range;
generating association conditions based on the range identification of the associated data range and the identification of the query object; and
obtaining the cross-query-object condition by combining the association conditions via a connection statement.
